(19) United States
(12) Patent Application Publication
(10) Pub. No.: US 2006/0041654 A1
(43) Pub. Date: Feb. 23, 2006

(54) Cooperative application starter program

(75) Inventors: Yuko Aki, Kawasaki (JP); Osamu Koyano, Kawasaki (JP); Hideto Hayakawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/010,149

(22) Filed: Dec. 10, 2004

(30) Foreign Application Priority Data
Aug. 17, 2004 (JP) 2004-236965

(51) Int. Cl. G06F 15/173

(52) U.S. Cl. 709/223

(57) ABSTRACT

A cooperative application starter program that makes it easy to register a cooperative application and change a registration regarding the cooperative application. In an integrated management server, a correspondence information generation section obtains unit management information and generates correspondence information by which cooperative applications are associated with application servers and units. A menu setting section generates start definition information for starting the cooperative applications by using the correspondence information and associates the start definition information with operation menus. The operation menus and the start definition information are generated according to the units. When any of the units is selected, an auxiliary menu execution section starts a cooperative application by using start definition information set for the unit selected.

### CROSS-REFERENCE TO RELATED APPLICATIONS

This application is based upon and claims the benefits of priority from the prior Japanese Patent Application No. 2004-236965, filed on Aug. 17, 2004, the entire contents of which are incorporated herein by reference.

### BACKGROUND OF THE INVENTION

(1) Field of the Invention

This invention relates to a cooperative application starter program and, more particularly, to a cooperative application starter program for starting cooperative applications dispersedly installed on servers connected via a network.

(2) Description of the Related Art

Conventionally, integrated management platforms have been installed for managing units which make up the entire system including a plurality of subsystems connected by a network. Integrated management platforms perform standard management on all of the units to be managed at normal times and perform detailed management at the time of needing detailed information regarding a specific unit or a specific group by starting cooperative applications installed on a group of application servers which cooperate with one another. These cooperative applications perform detailed management on specific groups of units.

To start cooperative applications as occasion demands, menus for starting the cooperative applications are associated with start uniform resource locators (URLs) where the cooperative applications are started on a one-to-one basis and they are registered in advance with an integrated management platform. That is to say, the IP addresses/node names of units to be managed menus for which are registered are associated with the names of the menus registered and start URLs for cooperative applications called when the menus are selected in order to perform registration. When any menu is selected, the integrated management platform calls a cooperative application on the basis of an IP address/node name which is included in a start URL of the cooperative application associated with the menu and registered and at which the cooperative application is installed. When the integrated management platform calls the cooperative application, the integrated management platform passes the IP address/node name of a unit to be managed registered on a menu to the start URL registered as a parameter. The integrated management platform starts the cooperative application in this way.

However, the integrated management platform merely calls the cooperative application on the basis of the registered start URL associated with the menu selected. Therefore, if the start URL for the cooperative application is added, changed, or deleted, a registration must be changed to call the cooperative application. An access method under which an object to be accessed which resides on a network can be accessed even in the case of access information for accessing the object to be accessed being changed by registering the correspondences before and after the change between them is proposed as a technique for automatically accommodating a change in object to be accessed, such as start URL, which resides on a network (see, for example, Japanese Unexamined Patent Publication No. 2002-268970, paragraph nos. [0018]-[0065] and FIG. 1).

With conventional application cooperation, however, registration for starting a cooperative application has been conducted manually. Accordingly, registration work is troublesome and it is not easy to change a registration.

With the conventional application cooperation, the correspondences between menus and start URLs for applications have been fixed on a one-to-one basis. However, if the number of units to be managed by one application server exceeds the limit, distributed processing must be performed by a plurality of servers. In this case, registration is conducted by generating different menu names for start URLs because only one start URL can be registered on one menu. Therefore, though the same application is installed on application servers, the number of menu names to be registered is the same as that of the application servers. Moreover, the registration work must be performed by a person who is familiar with the relationship between the servers on which the application is installed and groups of units to be managed by the servers. In this case, the menus are set manually and the start URLs are allocated to them. Such troublesome registration work is inefficient and often causes mistakes. In addition, it is not desirable from the viewpoint of the management of operation that there are different menus for the same application.

Furthermore, with the conventional application cooperation, a change in the correspondence between a menu and a start URL once registered must also be made manually. With the conventional application cooperation, the correspondence between application servers on which an application is installed and units to be managed by the application servers and the relationship between menus are not managed. Accordingly, when addition/deletion/change is made to application servers on which the same cooperative application is installed or when addition/deletion/change is made to information regarding units to be managed by the existing application servers on which the same cooperative application is installed, the addition/deletion/change is not reflected on operation menus registered. That is to say, all of the relevant operation menus registered must be changed manually. As a result, there occur mistakes in work or omissions. For example, when a group of units to be managed are added, the group of units to be managed must be registered with an integrated management platform, the group of units to be managed must be registered with a cooperative application, and the cooperative application must be registered with the group of units to be managed.

With the conventional method, correspondence information before and after a change regarding an object to be accessed is stored and registrations are changed on the basis of this information. However, this information must be referred to before the object to be accessed is accessed. As a result, a process becomes troublesome. In addition, this information must be stored. Accordingly, an extra memory area is required.

### SUMMARY OF THE INVENTION

The present invention was made under the background circumstances described above. An object of the present invention is to provide a cooperative application starter program that makes it easy to register a cooperative application and change a registration regarding the cooperative application.

In order to achieve the above object, a cooperative application starter program for starting cooperative applications dispersedly installed on a plurality of servers connected via a network is provided. This cooperative application starter program makes a computer function as a correspondence information generation section for obtaining unit management information regarding units to be managed generated by the plurality of servers on which the cooperative applications are installed and for generating correspondence information by which the cooperative applications are associated with the plurality of servers and the units to be managed on the basis of the unit management information; a menu setting section for setting operation menus regarding the units to be managed for starting the cooperative applications, for generating start definition information for indicating areas where objects for starting the cooperative applications associated with the units to be managed are stored by using the correspondence information, and for associating the start definition information with the operation menus; and an auxiliary menu execution section for providing, at the time of any of the units to be managed being selected, an operation menu set for the unit to be managed and for starting a cooperative application by using start definition information corresponding to the operation menu selected.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view of the present invention applied to embodiments.

FIG. 2 shows the configuration of a network system having an integrated management platform according to an embodiment of the present invention.

FIG. 3 is a block diagram showing the hardware configuration of an integrated management server.

FIG. 4 is a block diagram showing the software configuration of the integrated management server and a group of application servers.

FIG. 5 is a block diagram showing the software configuration of the integrated management server.

FIG. 6 shows an example of unit management information (generated by an application server A1-1) obtained by the integrated management server.

FIG. 7 shows an example of unit management information (generated by an application server A2-1) obtained by the integrated management server.

FIG. 8 shows an example of unit management information (generated by an application server A3-1) obtained by the integrated management server.

FIG. 9 shows an example of correspondence information generated by the integrated management server.

FIG. 10 shows an example of menu allocation information.

FIG. 11 shows an example of menu list information.

FIG. 12 shows an example of a screen displayed on the integrated management platform.

FIG. 13 shows an example of priority information.

FIG. 14 is a flow chart showing the processing procedure for executing a menu.

FIG. 15 is a flow chart showing the processing procedure for calling a cooperative application.

FIG. 16 is a flow chart showing the procedure for a priority setting process.

### DESCRIPTION OF THE PREFERRED EMBODIMENTS

Embodiments of the present invention will now be described with reference to the drawings. An overview of the present invention applied to embodiments will be given first and then the concrete contents of an embodiment will be described.

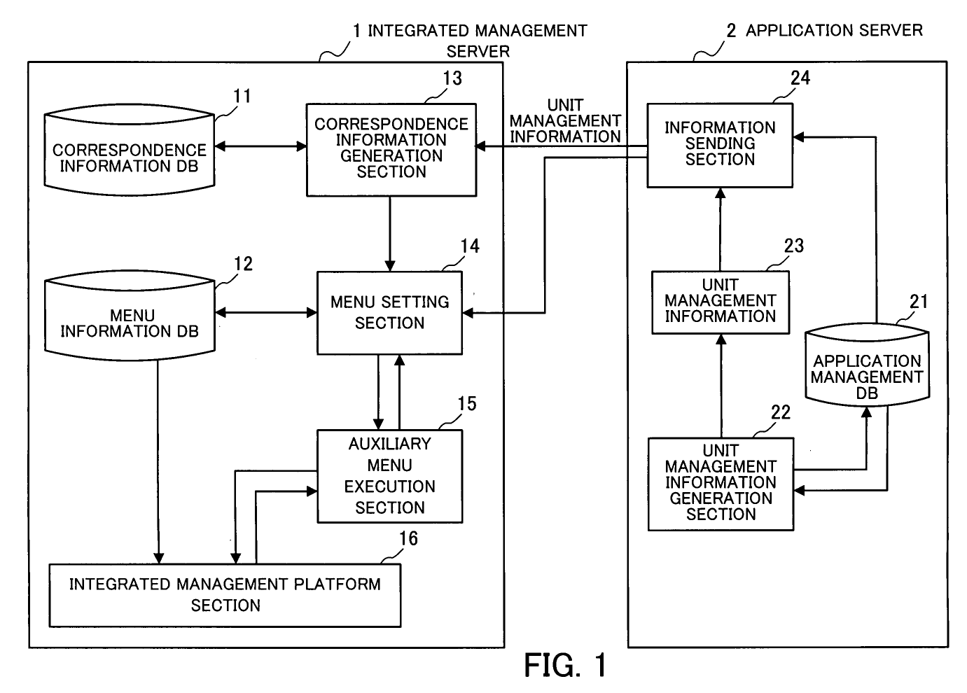

FIG. 1 is a schematic view of the present invention applied to embodiments.

An integrated management server 1 is connected to an application server 2 via a network and functions as an integrated management platform which manages each unit. The integrated management server 1 manages the entire system made up of a plurality of application servers including the application server 2. A cooperative application which can be started from the integrated management server 1 is dispersedly installed on application servers included in the system.

The integrated management server 1 includes a storage section including a correspondence information database (DB) 11 and a menu information database 12, a correspondence information generation section 13, a menu setting section 14, an auxiliary menu execution section 15, and an integrated management platform section 16. The application server 2 includes an application management database 21, a unit management information generation section 22, and an information sending section 24.

The correspondence information database 11 stores correspondence information generated by the correspondence information generation section 13 on the basis of unit management information obtained from the application server 2.

The menu information database 12 stores information regarding operation menus used by the menu setting section 14. For example, the menu information database 12 stores menu allocation information, menu list information, etc. regarding menus according to the properties of units. In addition, the menu information database 12 stores menu information regarding any unit set by the menu setting section 14 according to need.

The correspondence information generation section 13 begins a process when the unit management information is obtained from the application server 2. Information, such as node names, IP addresses, and properties, regarding units to be managed is registered according to cooperative applications which reside in the application server 2 as the unit management information. The correspondence information generation section 13 associates each cooperative application with an application server in which it resides and units to be managed by using the unit management information to generate the correspondence information.

The menu setting section 14 generates an operation menu for each unit on the basis of information, such as the menu allocation information and the menu list information, stored in the menu information database 12 and the correspondence information generated by the correspondence information generation section 13. This operation menu is used on the integrated management platform section 16 when a user starts a cooperative application. The operation menus which depend on the properties of units are defined as the menu allocation information. The menu setting section 14 searches the menu allocation information on the basis of the properties of units included in the correspondence information and sets operation menus corresponding to the units. Then the menu setting section 14 generates start definition information for starting an application corresponding to an operation menu set for each unit. Description format information for describing commands corresponding to operation menus or start definition information for cooperative applications is registered as the menu list information. Usually areas (URLs) where objects for starting cooperative applications are stored reside in each application server. The integrated management server 1 can start the cooperative applications by the URLs. The description format of the start definition information depends on cooperative applications. Descriptions from which the start definition information is obtained by entering predetermined data into predetermined places are set as the description format information. With the description format information “http://%SERVER%:XXX %IP%”, for example, %SERVER% is the IP address of an application server and %IP% is the IP address of a unit to be managed. The menu setting section 14 extracts information regarding the application server 2 and the unit to be managed by using the correspondence information, enters it into the description format information, and generates a start. URL for starting a cooperative application for the unit to be managed. The start URL generated is associated with an operation menu.

The process of generating start definition information and associating it with an operation menu is performed at the time of registering or executing the operation menu. If this process is performed at the time of registering the operation menu, an operation menu corresponding to each unit is set first. Just after that, the start definition information is generated and the start definition information is associated with the operation menus. Information regarding registered menus generated in this way is stored in the menu information database 12 and is referred to at the time of executing an operation menu. If this process is performed at the time of executing the operation menu and the operation menu is selected by the auxiliary menu execution section 15, the menu setting section 14 sets the start definition information corresponding to the operation menu for a unit to be managed and passes it to the auxiliary menu execution section 15.

The auxiliary menu execution section 15 receives designation of a unit to be managed from the integrated management platform section 16, provides an operation menu for this unit set by the menu setting section 14, and executes the operation menu selected. If start definition information set for the operation menu for this unit has been stored in the menu information database 12 by the menu setting section 14, the auxiliary menu execution section 15 extracts and uses it at the time of executing the operation menu. If start definition information is not associated with the operation menu at the time of executing the operation menu, the auxiliary menu execution section 15 requires the menu setting section 14 to set start definition information and starts a cooperative application with the start definition information obtained.

The integrated management platform section 16 integrates and manages the entire system. When an operator inputs instructions to perform a process on any unit by using a predetermined cooperative application, the integrated management platform section 16 informs the auxiliary menu execution section 15 of the unit to be managed and requests it to start a cooperative application.

The application management database 21 stores application management information for managing cooperative applications. Start URLs for starting applications are set as the application management information.

The unit management information generation section 22 generates unit management information 23 for managing a particular group of units managed by the application server 2. The node name, IP address, and property (router, switch, client, or the like) of a unit included in the particular group of units are set as the unit management information 23.

The information sending section 24 sends the unit management information 23 generated by the unit management information generation section 22 and the application management information to the integrated management server 1 at the time of a read request from the integrated management server 1, in a constant cycle, or at the time of a change in the configuration of a subsystem included in the application server 2, for example.

The operation of the integrated management server 1 having the above structure will now be described.

Unit management information regarding a unit to be managed is sent from the application server 2 to the integrated management server 1 with predetermined timing when there is a change in the state. For example, unit management information is sent from the application server 2 to the integrated management server 1 when a unit to be managed by the application server 2 is deleted, when a unit to be managed by the application server 2 is added, when a cooperative application installed on the application server 2 is deleted, or when a cooperative application is added to the application server 2. On the integrated management server 1 side, the correspondence information generation section 13 generates correspondence information by associating the cooperative application with the application server 2 in which it resides and units to be managed on the basis of the unit management information obtained and stores the correspondence information in the correspondence information database 11. The menu setting section 14 uses the correspondence information and the menu allocation information, searches the menu allocation information with the property of each unit as a key, and sets an operation menu for each unit. Then the menu setting section 14 generates start definition information for starting a cooperative application corresponding to an operation menu and associates the start definition information with the operation menu. This process is performed just after an operation menu for each unit being set or at the time of the operation menu being selected by the auxiliary menu execution section 15.

If a unit to be selected is not designated at the time of, for example, starting a cooperative application after the correspondence information being set, operation menus for all of the units are set and information set is stored in the menu information database 12. It takes time to set the operation menus. By doing so, however, a quick response can be made when a request to display an operation menu is made from the integrated management platform section 16 via the auxiliary menu execution section 15. Moreover, once the operation menus are set, there is no need to set operation menus before a change in the state.

To start a cooperative application from the auxiliary menu execution section 15, an operation menu for a unit selected by a user is set. In this case, there is no need to store information set in the menu information database 12. This reduces a memory area required. Which method to select is set properly according to systems.

The operation menu is set by the above-mentioned processing procedure and is provided to the user. When the user selects the operation menu, the auxiliary menu execution section 15 starts the cooperative application by start definition information corresponding to the operation menu selected.

As described above, a cooperative application is associated with an application server in which it resides and units to be managed. As a result, when a unit to be managed is selected, the application server is automatically selected and the target cooperative application can be started. Compared with conventional cases where such associating is performed manually, mistakes in registration work can be prevented and the registration work load can be lightened significantly. Moreover, the correspondence information is held by the integrated management server 1, so there is no need to change the name of an operation menu in accordance with start definition information for starting a cooperative application corresponding to each unit. This makes management operation on an integrated management platform easy.

A case where the embodiment is applied to an integrated management platform for monitoring units included in a system having a group of application servers connected to one another by a network will now be described in detail with reference to the drawings.

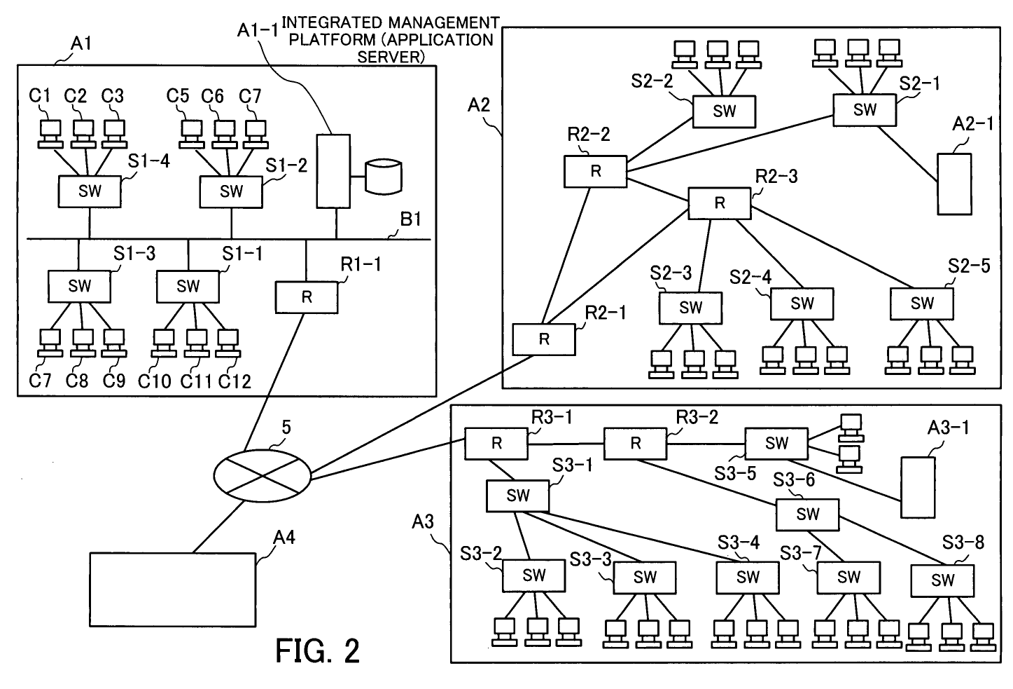

FIG. 2 shows the configuration of a network system having an integrated management platform according to the embodiment.

A network system according to an embodiment of the present invention includes a subsystem A1 having an application server A1-1 which also functions as an integrated management platform and in which cooperative applications reside, a subsystem A2 having an application server A2-1 on which cooperative applications reside, a subsystem A3 having an application server A3-1, and a subsystem A4 having the same structure as the other subsystems. These subsystems are connected to one another via a network 5, such as the Internet.

In the subsystem A1 having the application server A1-1 which also functions as an integrated management platform, the application server A1-1, a router (R) R1-1 which connects with the network 5, and switches (SW) S1-1, S1-2, S1-3, and S1-4 each of which connects with clients are connected to one another via an internal bus B1. The router R1-1 establishes a communication path between each unit in the subsystem A1 and the external network 5. The switch S1-1 connects clients C10, C11, and C12 to the internal bus B1. Similarly, the switch S1-2 connects clients C5, C6, and C7 to the internal bus B1, the switch S1-3 connects clients C7, C8, and C9 to the internal bus B1, and the switch S1-4 connects clients C1, C2, and C3 to the internal bus B1. The application server A1-1 not only manages units to be managed included in the subsystem A1 but also functions as an integrated management server which manages the entire system made up of the subsystems A1, A2, A3, and A4 as an integrated management platform.

The subsystem A2 includes the application server A2-1, a router R2-1 which connects with the network 5, routers R2-2 and R2-3 which establish communication paths in the subsystem A2, and switches S2-1, S2-2, S2-3, S2-4, and S2-5 each of which connects with clients. The router R2-1 establishes a communication path between each unit in the subsystem A2 and the external network 5. A communication path in the subsystem A2 is determined by the routers R2-1, R2-2, and R2-3. The switch S2-1 connects the clients and the application server A2-1 to the router R2-2. Similarly, the switch S2-2 connects the clients to the router R2-2 and each of the switches S2-3, S2-4, and S2-5 connects the clients to the router R2-3. The application server A2-l manages units to be managed included in the subsystem A2.

The subsystem A3 includes the application server A3-1, a router R3-1 which connects with the network 5, a router R3-2 which establishes a communication path in the subsystem A3, and switches S3-1, S3-2, S3-3, S3-4, S3-5, S3-6, S3-7, and S3-8 each of which connects with clients. The router R3-1 establishes a communication path between each unit in the subsystem A3 and the external network 5. A communication path in the subsystem A3 is determined by the routers R3-1 and R3-2. The switch S3-1 connects the switches S3-2, S3-3, and S3-4 to the router R3-1. Each of the switches S3-2, S3-3, and S3-4 connects the clients to the switch S3-1. The switch S3-5 connects the clients and the application server A3-1 to the router R3-2. The switch S3-6 connects the switches S3-7 and S3-8 to the router R3-2. Each of the switches S3-7 and S3-8 connects the clients to the switch S3-6. The application server A3-1 manages units to be managed included in the subsystem A3.

The structure of the subsystem A4 is the same as that of the other subsystems.

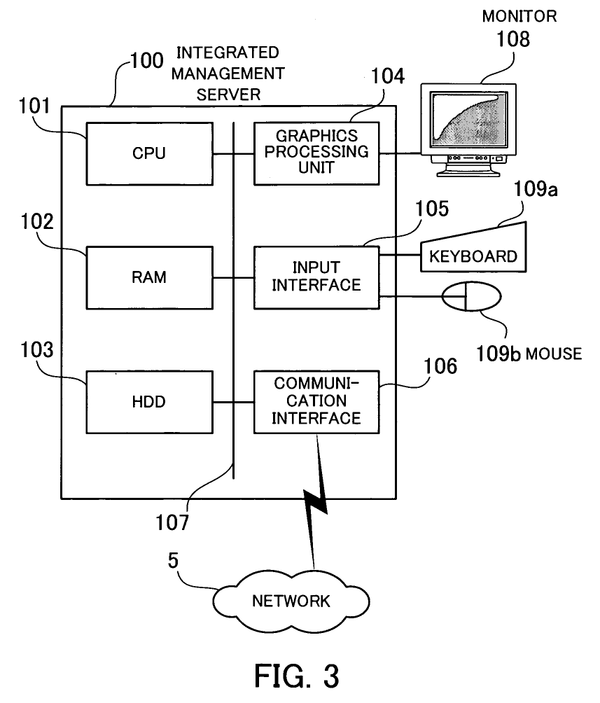

The hardware configuration of an integrated management server which functions as the integrated management platform will now be described. FIG. 3 is a block diagram showing the hardware configuration of an integrated management server.

The whole of an integrated management server 100 is controlled by a central processing unit (CPU) 101. A random access memory (RAM) 102, a hard disk drive (HDD) 103, a graphics processing unit 104, an input interface 105, and a communication interface 106 are connected to the CPU 101 via a bus 107.

The RAM 102 temporarily stores at least part of an operating system (OS) or an application program executed by the CPU 101. The RAM 102 also stores various pieces of data which the CPU 101 needs to perform a process. The HDD 103 stores the OS and application programs. A monitor 108 is connected to the graphics processing unit 104. In accordance with instructions from the CPU 101, the graphics processing unit 104 displays an image on a screen of the monitor 108. A keyboard 109a and a mouse 109b are connected to the input interface 105. The input interface 105 sends a signal sent from the keyboard 109a or the mouse 109b to the CPU 101 via the bus 107. The communication interface 106 is connected to a network 5 and exchanges data with an application server, a terminal unit, or the like via the network. In this example, the monitor 108, the keyboard 109a, and the mouse 109b are connected directly to the integrated management server 100. However, the monitor 108, the keyboard 109a, and the mouse 109b may be connected to a client computer which connects with the integrated management server 100 via the network 5. By doing so, the process of displaying a screen or inputting instructions can be performed via the client computer.

The processing function of the embodiment can be realized by adopting the above-mentioned hardware configuration. In FIG. 3, the hardware configuration of the integrated management server is shown. The hardware configuration of the cooperative application servers is the same as that of the integrated management server.

The software configuration of the integrated management server and the group of application servers which cooperate with the integrated management server will now be described. Programs are executed by computers. As a result, the processing functions of the integrated management server and the application servers are realized.

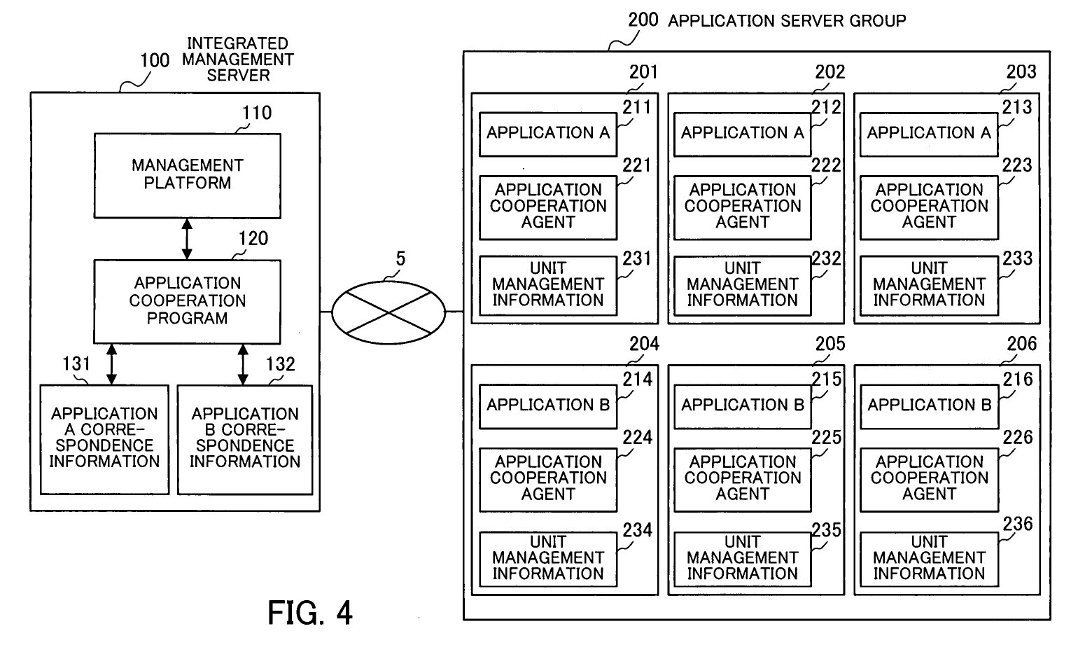

FIG. 4 is a block diagram showing the software configuration of the integrated management server and the group of application servers. Components in FIG. 4 that are the same as those shown in FIG. 3 are marked with the same numbers. The integrated management server may not be independent. In other words, the integrated management server may also function as one of the group of application servers.

An integrated management server 100 includes a management platform 110 and an application cooperation program 120. They manage the entire system in cooperation with one another. In addition, application A correspondence information 131 for an application A, being a cooperative application, and application B correspondence information 132 for an application B, being a cooperative application, reside in the integrated management server 100.

The management platform 110 realizes the function of managing the entire system. In the normal state the management platform 110 collects standard general information, such as monitoring information, from units to be managed which are network apparatus such as servers, clients, routers, and switches and which reside on the system, and provides it to a user. When detailed information which cannot be collected by such a normal process is required, the management platform 110 requests the application cooperation program 120 to start a cooperative application. The management platform 110 gets the detailed information obtained by the cooperative application started by the application cooperation program 120 and provides it to the user.

The application cooperation program 120 is a cooperative application starter program for starting a cooperative application. The application cooperation program 120 obtains pieces of unit management information 231, 232, 233, 234, 235, and 236 generated by application servers 201, 202, 203, 204, 205, and 206, respectively, included in an application server group 200, generates correspondence information (application A correspondence information 131 and application B correspondence information 132) for each application on the basis of these pieces of unit management information, and generates operation menus (hereinafter, menus) for starting the cooperative applications on the basis of the correspondence information. When a menu is designated, the application cooperation program 120 starts the corresponding cooperative application.

The application servers 201, 202, 203, 204, 205, and 206 included in the application server group 200 perform processes in cooperation with the application cooperation program 120 which resides in the integrated management server 100 by application cooperation agents 221, 222, 223, 224, 225, and 226, respectively. A cooperative application resides in each application server. In this example, the application A (211, 212, and 213), being a cooperative application, resides in the application servers 201, 202, and 203 and the application B (214, 215, and 216), being a cooperative application, resides in the application servers 204, 205, and 206. The application servers 201, 202, 203, 204, 205, and 206 generate and hold the pieces of unit management information 231, 232, 233, 234, 235, and 236, respectively, regarding units to be managed.

The application cooperation agents 221, 222, 223, 224, 225, and 226 generate the pieces of unit management information 231, 232, 233, 234, 235, and 236, respectively, and perform the processes of starting the cooperative applications in cooperation with the application cooperation program 120 which resides in the integrated management server 100.

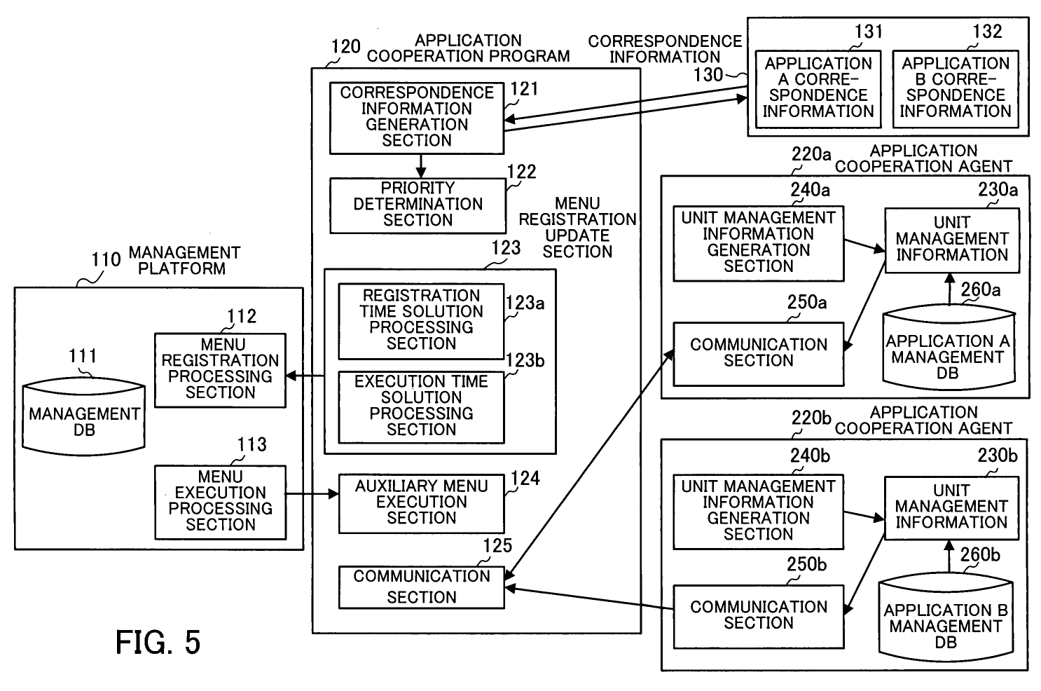

The software configuration of the integrated management server and the corresponding application servers will now be described in more detail. FIG. 5 is a block diagram showing the software configuration of the integrated management server. Components in FIG. 5 that are the same as those shown in FIG. 4 are marked with the same numbers.

The management platform 110 includes a management database 111 which stores management information, a menu registration processing section 112 which performs a menu registration process, and a menu execution processing section 113. The menu registration processing section 112 registers a latest menu updated by a menu registration update section 123 and provides it at a user's request. For example, the menu registration processing section 112 displays it on a display unit. When a menu to be started is selected on the instructions of the user, the menu execution processing section 113 requests an auxiliary menu execution section 124 to perform the process of executing this menu.

The application cooperation program 120 includes a correspondence information generation section 121, a priority determination section 122, the menu registration update section 123, the auxiliary menu execution section 124, and a communication section 125.

The correspondence information generation section 121 obtains unit management information generated by an application cooperation agent 220 via the communication section 125, generates correspondence information 130, and holds it in a storage unit. This correspondence information is generated according to cooperative applications. In this example, the application A correspondence information 131 regarding the cooperative application A and the application B correspondence information 132 regarding the cooperative application B are generated.

If the same unit is to be managed by the same cooperative application dispersedly installed on a plurality of application servers, the priority determination section 122 sets priorities. As shown in FIG. 4, the cooperative applications are dispersedly installed on a plurality of application server. In some cases, the same unit is to be managed by a plurality of application servers. The priority determination section 122 compares a unit to be managed registered in the application A correspondence information 131 with the other units to be managed registered in the application A correspondence information 131. Similarly, the priority determination section 122 compares a unit to be managed registered in the application B correspondence information 132 with the other units to be managed registered in the application B correspondence information 132. If the same unit is to be managed by different application servers, then the priority determination section 122 sets priorities for these application servers and adds them to the application A correspondence information 131 or the application B correspondence information 132.

The menu registration update section 123 is used for setting a menu. The menu registration update section 123 sets a menu for each unit on the basis of the correspondence information and the menu allocation information and informs the menu registration processing section 112 of it. The menu registration update section 123 includes a registration time solution processing section 123a and an execution time solution processing section 123b for generating a start URL for starting a cooperative application according to a menu set for each unit and for associating it with the menu. The registration time solution processing section 123a generates a start URL at menu registration time. That is to say, the registration time solution processing section 123a generates a start URL associated with a menu set for each unit and holds it as information regarding registered menus. When a menu is selected, the execution time solution processing section 123b generates a start URL corresponding to the menu.

When the menu execution processing section 113 included in the management platform 110 designates a menu to be executed, the auxiliary menu execution section 124 starts a cooperative application by using start definition information corresponding to the menu.

The communication section 125 controls an exchange of data with a communication section 250 in an application server to which it is connected via a network.

An application cooperation agent 220a on the application server side is an application cooperation agent for the cooperative application A and includes a unit management information generation section 240a, a communication section 250a, and an application A management database 260a. The unit management information generation section 240a generates unit management information 230a regarding units to be managed. Information, such as node names, IP addresses, and properties, regarding the units to be managed by the cooperative application A is registered in the unit management information 230a. The communication section 250a controls an exchange of data with the integrated management server 100 to which it is connected via a network. The application A management database 260a stores a start pointer indicative of an area where a start object for starting the application A is stored.

Similarly, an application cooperation agent 220b on the application server side is an application cooperation agent for the cooperative application B and includes a unit management information generation section 240b, a communication section 250b, and an application B management database 260b. The unit management information generation section 240b generates unit management information 230b regarding units to be managed. Information, such as node names, IP addresses, and properties, regarding the units to be managed by the cooperative application B is registered in the unit management information 230b. The communication section 250b controls an exchange of data with the integrated management server 100 to which it is connected via a network. The application B management database 260b stores a start pointer indicative of an area where a start object for starting the application B is stored.

The processing function of the above-mentioned integrated management server is realized by executing the cooperative application starter program.

The operation of the integrated management server and the application server group each having the above-mentioned structure will now be described.

The integrated management server 100 obtains the unit management information 231, 232, 233, 234, 235, and 236 generated by the application servers 201, 202, 203, 204, 205, and 206, respectively, included in the application server group 200 and generates correspondence information for each cooperative application.

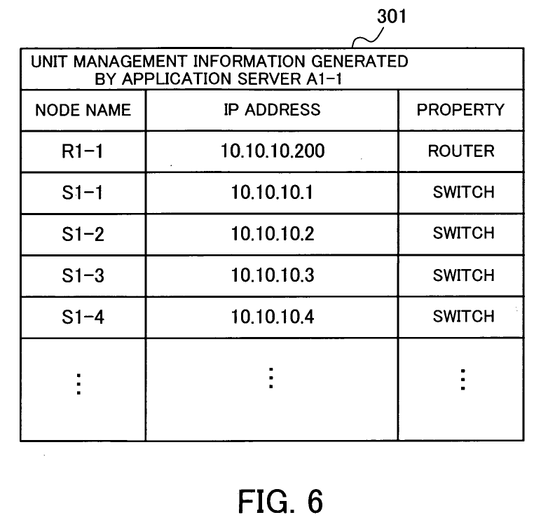

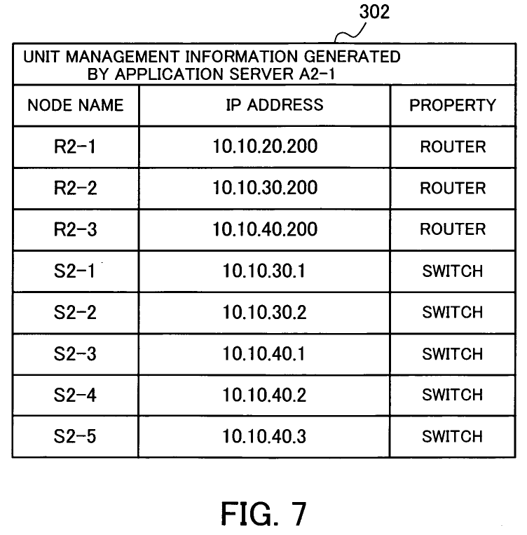

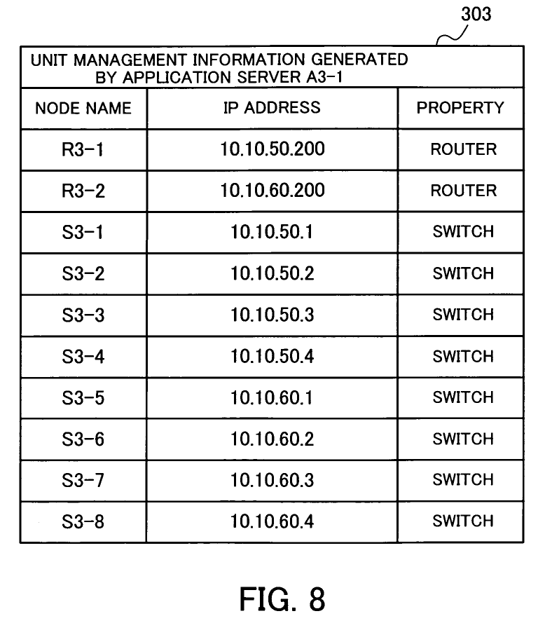

Unit management information will now be described. FIGS. 6 through 8 show examples of the unit management information the integrated management server obtains. FIG. 6 shows an example of unit management information generated by the application server A1-1 shown in FIG. 2. FIG. 7 shows an example of unit management information generated by the application server A2-1 shown in FIG. 2. FIG. 8 shows an example of unit management information generated by the application server A3-1 shown in FIG. 2. These pieces of unit management information pertain to the same cooperative application (in this example, the application A).

The node names, IP addresses, and properties of units to be managed by the application server A1-1 are registered as unit management information 301 regarding the application A generated by the application server A1-1. In this example, the node name, IP address, and property of the router R1-1 are registered as R1-1, 10.10.10.200, and router, respectively. The information regarding the router R1-1 is followed by unit management information regarding the switches S1-1, S1-2, S1-3, and S1-4.

Similarly, the node names, IP addresses, and properties of units to be managed by the application server A2-1 are registered as unit management information 302 regarding the application A generated by the application server A2-1. In addition, the node names, IP addresses, and properties of units to be managed by the application server A3-1 are registered as unit management information 303 regarding the application A generated by the application server A3-1.

These pieces of unit management information may be generated manually by a user in accordance with a designated format and be registered with the integrated management server 100.

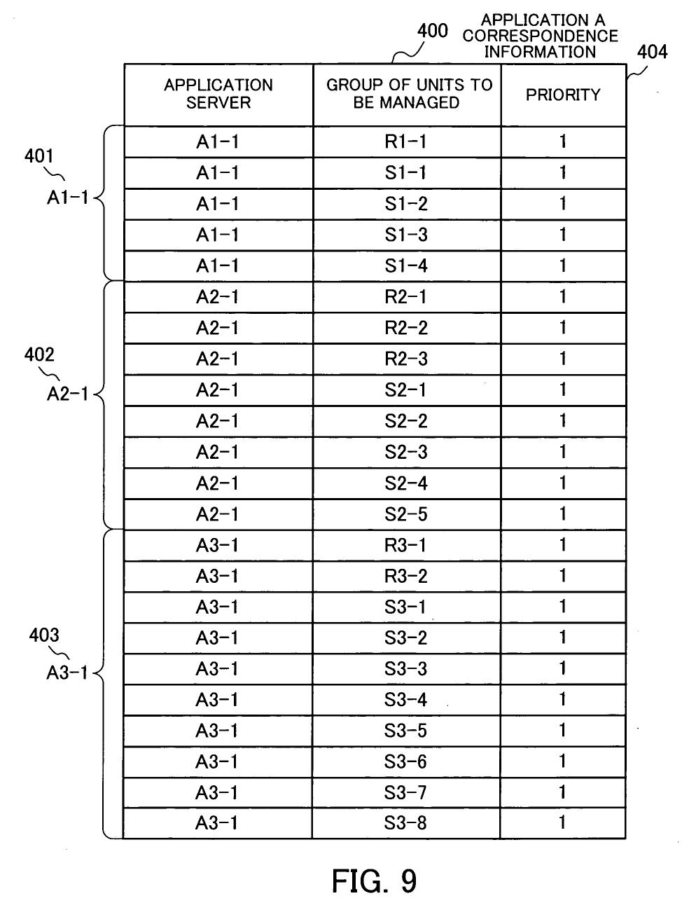

The correspondence information generation section 121 included in the integrated management server 100 generates correspondence information regarding the application A by using these pieces of unit management information. FIG. 9 shows an example of correspondence information generated by the integrated management server. In this example, correspondence information regarding the application A is shown. Pieces of unit management information obtained from each application server are arranged according to application servers in application A correspondence information 400. Pieces of information (such as node names and IP addresses) regarding the application servers in which the application A resides are set in an Application Server field. In this example, these pieces of information are simply expressed as “A1-1,” “A2-1,” and “A3-1”. Unit management information obtained from each application server entered in the Application Server field is stored in a Group of Units to be Managed field. The unit management information 301 shown in FIG. 6 and obtained from the application server A1-1 is stored in an A1-1 area 401. The unit management information 302 shown in FIG. 7 and obtained from the application server A2-1 is stored in an A2-1 area 402. The unit management information 303 shown in FIG. 8 and obtained from the application server A3-1 is stored in an A3-1 area 403. In this example, these pieces of unit management information are simply expressed by node names.

Priorities for starting the same cooperative application set for a unit to be managed by a plurality of application servers with the same cooperative application are stored in a Priority field 404. The priorities are set by the priority determination section 122 and are registered in the application A correspondence information 400. The priority determination section 122 compares the IP addresses of units registered in the Group of Units to be Managed field. If the IP addresses of the units are not the same, then the priority “1” (top priority) is set for these units. If the IP addresses of the units are the same, then the priority “1” is set for one of them and the priority “2” (lower than the priority “1”) is set for the other. If the IP addresses of three or more units are the same, then the priorities “1,” “2,” “3,” and so on are set for them in the same way.

In this example, the same IP address does not exist, so the priority “1” is set for all of the units.

A menu is set for each unit on the basis of such correspondence information. The menu registration update section 123 refers to the menu allocation information in which menus according to the properties of units are defined, and registers a menu for each unit. The menu registration update section 123 informs the menu registration processing section 112 of the menu registered.

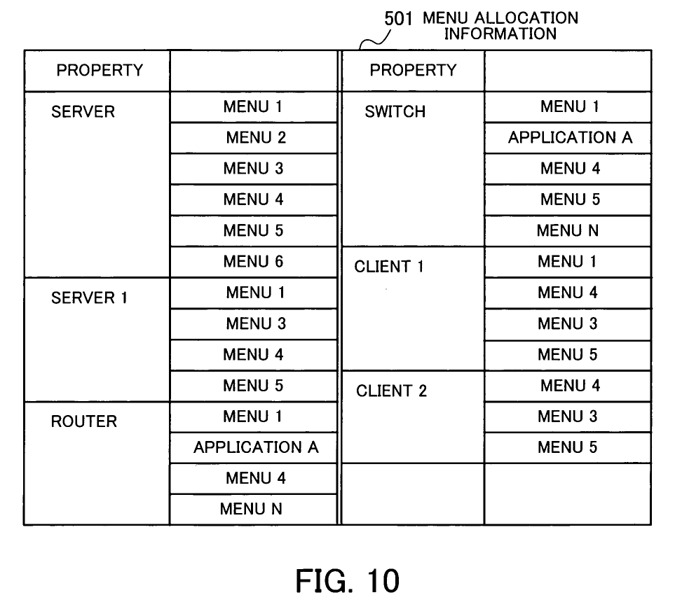

Description will now be given by giving a concrete example. FIG. 10 shows an example of the menu allocation information.

Menu items according to the properties of units are defined in menu allocation information 501. For example, if the property of a unit is a server, then “menu 1,” “menu 2,” “menu 3,” “menu 4,” “menu 5,” and “menu 6” are registered. Similarly, if the property of a unit is a router, then “menu 1,” “application A,” “menu 4,” and “menu N” are registered. In addition, if the property of a unit is a switch, then “menu 1,” “application A,” “menu 4,” “menu 5,” and “menu N” are registered.

These menu items are names which are set so that a user can identify the types of processes at the time of selecting a process to be started. These menu items are associated with cooperative applications to be started or commands on a one-to-one basis.

After a menu for each unit is set in accordance with the above-mentioned processing procedure, a start URL for starting a cooperative application corresponding to each menu is set. A start URL is generated and is associated with a menu at menu registration time or menu execution time.

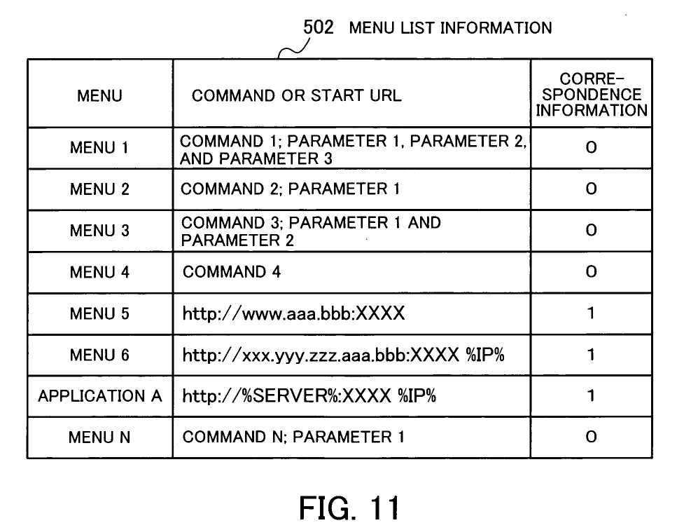

A method for generating a start URL and associating it with a menu at menu registration time will be described first. To generate a start URL, the menu list information including menu items, the corresponding operation information, and the presence or absence of correspondence information regarding the operation information is referred to. Description will now be given by giving a concrete example. FIG. 11 shows an example of the menu list information.

Commands or start URLs corresponding to menu items and the presence or absence of correspondence information regarding the commands or start URLs are registered in menu list information 502.

The commands included in the menu list information 502 are execution commands and parameters are set for them. The commands are instructions processed in the integrated management server 100, so correspondence information regarding them does not exist (“0” is registered). In this example, “menu 1,” “menu 2,” “menu 3,” “menu 4,” and “menu N” correspond to execution commands. The pieces of operation information set in the menu list information are associated with these menus and are registered by the menu registration processing section 112.

The menu list information 502 includes start URLs each including a variable parameter as description format information set according to cooperative applications. The value of each variable parameter is set variably according to the IP address of a unit to be managed or an application server which starts a cooperative application. In this example, variable parameters are set in spaces enclosed by %'s. For example, the IP address of a unit to be managed is set in a space enclosed by %'s in the operation information corresponding to “menu 6”. In addition, in the operation information corresponding to “application A,” the IP address of an application server is set in the first space enclosed by %'s and the IP address of a unit to be managed is set in the second space enclosed by %'s. The operation information corresponding to “menu 5” does not include a variable parameter. To generate a start URL and associate it with a menu at menu registration time, the menu is set and then the start URL “http://A3-1:XXXXR3-2” is completed by substituting the IP address of an application server or a unit to be managed obtained from correspondence information for a variable parameter. For example, it is assumed that a unit to be managed is the router R3-2 in the subsystem A3 included in the system shown in FIG. 2. In the application A correspondence information 400 shown in FIG. 9, an application server corresponding to R3-2 is A3-1. Therefore, in the operation information corresponding to “application A,” the IP address of the application server A3-1 is set in the first space enclosed by %'s and the IP address of the router R3-2 is set in the second space enclosed by %'s. As a result, the start URL is completed. The start URL completed is associated with the menu and is registered by the menu registration processing section 112.

By performing the above-mentioned processing procedure, the start URL is registered with the management platform concurrently with the registration of the menu. In this case, the start URL has been generated and associated with the menu when the menu is executed on the management platform. Accordingly, to call the cooperative application, the start URL registered is used and the menu is executed.

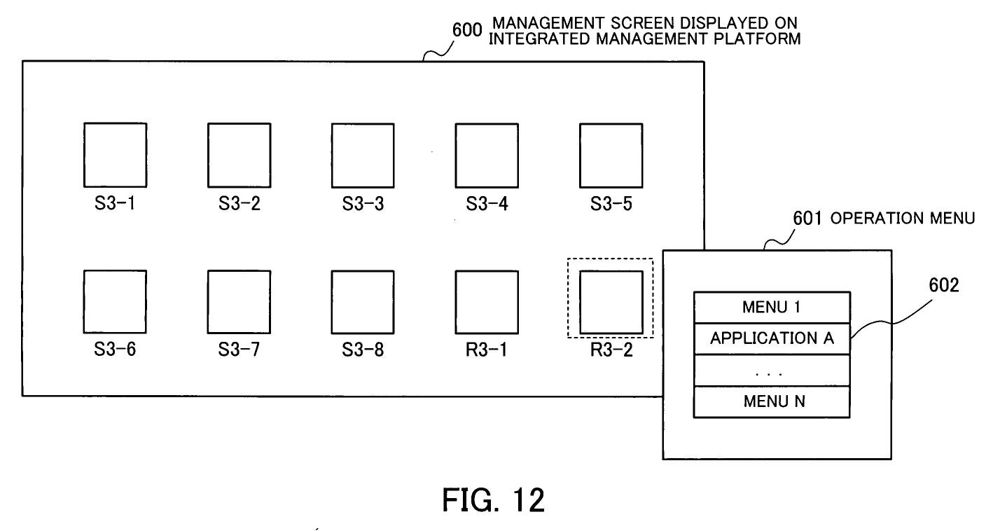

FIG. 12 shows an example of a screen displayed on the integrated management platform.

A group of units to be managed included in the system are displayed on a management screen 600 displayed on the integrated management platform. In this example, the switches and the routers included in the subsystem A3 shown in FIG. 2 are displayed. For example, when a user selects the router R3-2, a menu for the router R3-2 registered by the menu registration update section 123 is displayed in an Operation Menu area 601. When an “application A” 602 is selected from the menu, the appropriate cooperative application is started by a start URL which is completed by the registration time solution processing section 123a at menu registration time, which is associated with the menu, and which is registered.

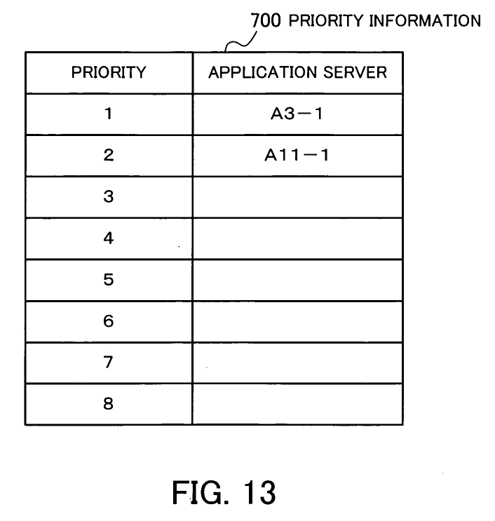

If the same unit is to be managed by a plurality of application servers, priorities are set. FIG. 13 shows an example of priority information.

In priority information 700, the priority “1” (top priority) and the priority “2” (second priority) are set for the application server A3-1 and an application server A11-1, respectively, by which a unit is to be managed. Priority information is information regarding priorities set if the same IP address is included in the IP addresses of units to be managed set in correspondence information. In the application A correspondence information 400 shown in FIG. 9, for example, the IP address of the unit R3-2 to be managed appears in the A3-1 area 403 corresponding to the application server A3-1. Accordingly, the priority “1” is set for the application server A3-1. If the same IP address appears in an area corresponding to the application server A11-1, then the priority “2” is set for the application server A11-1. Priorities are set in order in this way. The priority information 700 is generated at menu registration time or menu execution time by extracting a priority set for each unit to be managed in correspondence information.

Next, a method for generating a start URL and associating it with a menu at menu execution time will be described.

If the process of generating a start URL and associating it with a menu is not performed when the menu is registered, a start URL including a variable parameter set in the menu list information 502 shown in FIG. 11 is associated with the menu and is registered.

At menu execution time, the execution time solution processing section 123b completes the start URL by substituting the IP address of a unit to be managed or an application server obtained from correspondence information for the variable parameter. This process is the same as that performed in the case of generating a start URL and associating it with a menu at menu registration time. The process of generating a start URL and associating it with a menu at menu execution time may be performed by the menu execution processing section 113 included in the management platform 110.

If a change is made, that is to say, if a unit to be managed or an application server is added or deleted, the above-mentioned processes are performed only on an object of the change.

The processing procedure from the selection of a unit to the start of a cooperative application (in this example, application A) will now be described. It is assumed that the process of generating a start URL and associating it with a menu is performed at menu execution time.

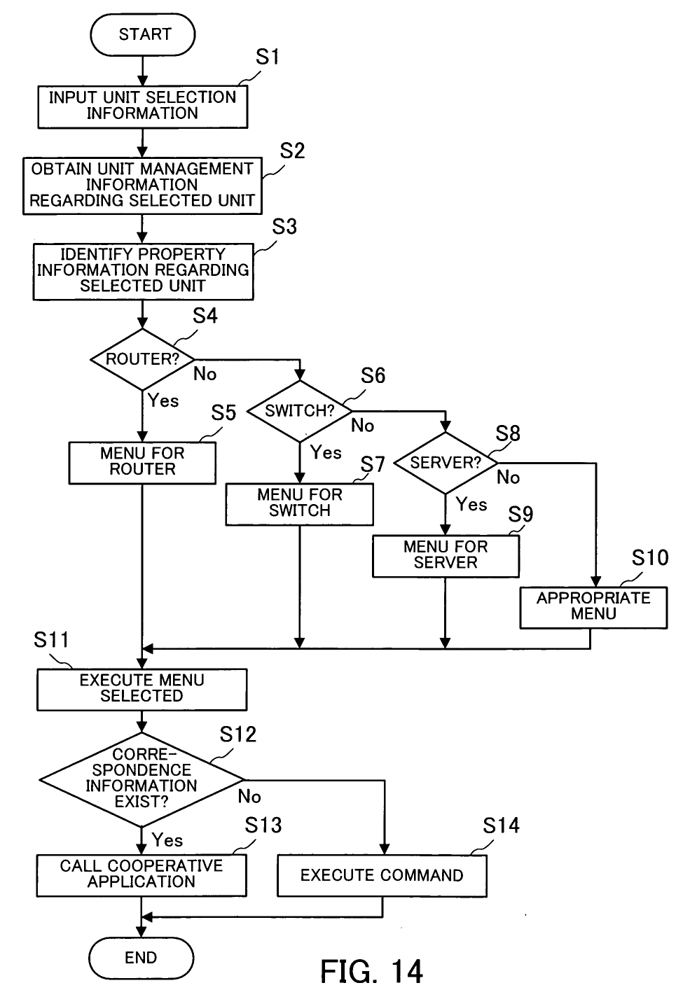

FIG. 14 is a flow chart showing the processing procedure for executing a menu. When a user selects a unit to be managed, a process is begun.

[Step S1] When a user selects a unit to be managed on a management screen displayed on the integrated management platform, unit selection information regarding the selected unit to be managed is inputted.

[Step S2] Unit management information is searched on the basis of the unit selection information, unit management information regarding the selected unit is obtained, and information, such as a node name, an IP address, and a property, is given. The unit selection information is held in a selected unit information storage area in the management platform.

[Step S3] Property information regarding the selected unit obtained in step S2 is identified.

[Step S4] Whether or not the property of the selected unit is a router is determined. If the property of the selected unit is not a router, then step S6 is performed.

[Step S5] If the property of the selected unit is a router, then a menu set for the router is displayed on a display screen of a display unit and step S11 is performed.

[Step S6] Whether or not the property of the selected unit is a switch is determined. If the property of the selected unit is not a switch, then step S8 is performed.

[Step S7] If the property of the selected unit is a switch, then a menu set for the switch is displayed on the display screen of the display unit and step S11 is performed.

[Step S8] Whether or not the property of the selected unit is a server is determined. If the property of the selected unit is not a server, then step S10 is performed.

[Step S9] If the property of the selected unit is a server, then a menu set for the server is displayed on the display screen of the display unit and step S11 is performed.

[Step S10] Another appropriate menu is displayed on the display screen of the display unit.

[Step S11] When a menu selected by the user from the menu displayed on the display screen of the display unit is communicated, the process of executing the menu selected is begun.

[Step S12] The menu list information is referred to and whether or not correspondence information is set for the menu selected is determined. If correspondence information is not set for the menu selected, then step S14 is performed.

[Step S13] The menu selected is a process to be performed by a cooperative application correspondence information for which is set. Therefore, this correspondence information is used, the cooperative application is called, and the process terminates.

[Step S14] The menu selected is a process to be performed by a command correspondence information for which is not set. Therefore, this command is executed and the process terminates.

By performing the above-mentioned processing procedure, a menu set for a unit selected is displayed on the display screen of the display unit. When the user selects a menu, the menu selected is executed. If the menu selected is a process executed by a command, then the command corresponding to the menu is executed. If the menu selected is a process executed by a cooperative application, then this cooperative application is started by using correspondence information associated with the menu selected and the process is performed.

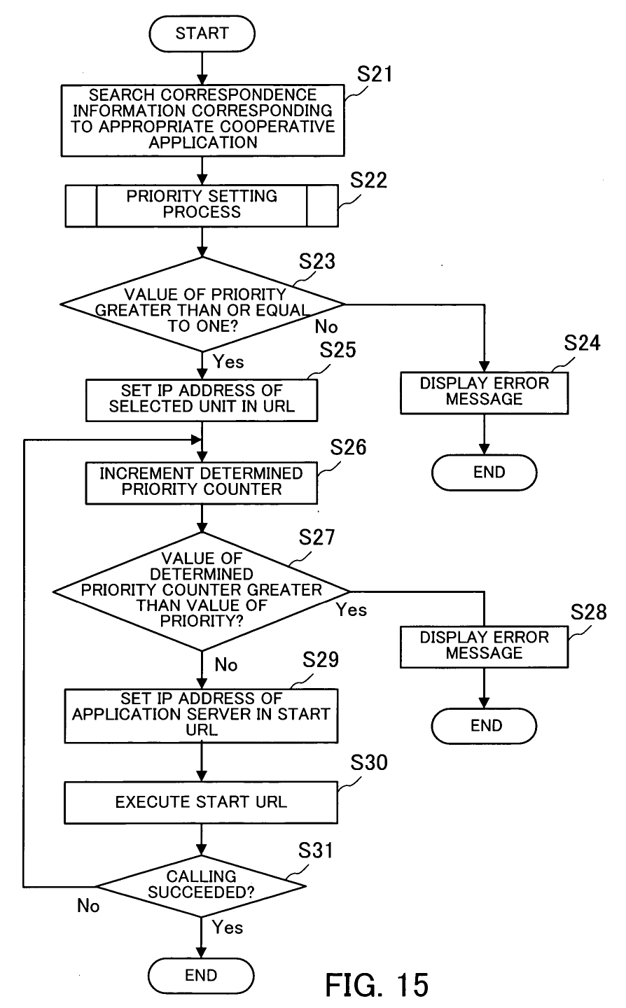

The process of calling a cooperative application on the basis of correspondence information will now be described. FIG. 15 is a flow chart showing the processing procedure for calling a cooperative application. By performing the processing procedure shown in FIG. 14, a selected menu is set and unit management information, such as an IP address, regarding a unit selected is stored in the selected unit information storage area.

[Step S21] Correspondence information corresponding to a cooperative application, being the selected menu, is searched. A determined priority counter is initialized to one before the process is begun.

[Step S22] A priority setting process is performed on the basis of the correspondence information corresponding to the cooperative application searched. If a plurality of application servers by which the unit is to be managed are detected in the priority setting process, then priorities for execution are set. The details will be described later. After the priority setting process terminates, the values of the priorities set are stored in the Priority field.

[Step S23] Whether the value of the priority set by the priority setting process (step S22) is greater than or equal to one, that is to say, whether an application server by which the unit is to be managed exists is determined. If the value of the priority set is not zero, then step S25 is performed.

[Step S24] The value of the priority set is zero. This means that the selected unit has not yet been registered with the application A. As a result, the error message “The selected unit has not yet been registered with the application A.” is displayed and the process terminates.

[Step S25] A start URL including a variable parameter which has been registered is read and the IP address of the selected unit is substituted for the variable parameter.

[Step S26] The determined priority counter is incremented.

[Step S27] The value of the determined priority counter and the value of the priority set are compared to determine whether the value of the determined priority counter is greater than the value of the priority set. If the value of the determined priority counter is not greater than the value of the priority set, then step S29 is performed.

[Step S28] The value of the determined priority counter is greater than the value of the priority set. This means that an application server which can start the cooperative application does not exist. As a result, the error message “The calling of the application A failed.” is displayed and the process terminates.

[Step S29] The value of the determined priority counter is not greater than the value of the priority set. This means that an application server which can start the cooperative application exists. Therefore, the priority information 700 is searched for an application server the priority of which is equal to the value of the determined priority counter. Then the IP address of the application server is set in the start URL in which the IP address of the selected unit is set in step S25.

[Step S30] The start URL completed is executed to call the cooperative application.

[Step S31] Whether the calling of the cooperative application succeeded is determined. If the calling of the cooperative application failed, then the process returns to step S26 to attempt a start process again by incrementing the determined priority counter. If the calling of the cooperative application succeeded, then the process terminates.

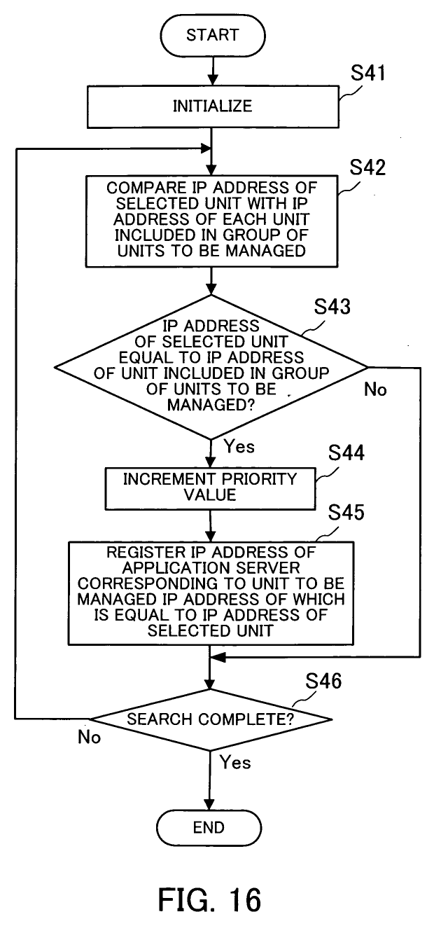

The priority setting process will now be described. FIG. 16 is a flow chart showing the procedure for the priority setting process.

[Step S41] The values of priorities are initialized to zeros. A pointer is set so that it will point at the head of the appropriate corresponding information.

[Step S42] The IP address of the selected unit is compared with the IP address of each unit included in a group of units to be managed in order.

[Step S43] Whether the IP address of the selected unit is equal to the IP address of a unit included in the group of units to be managed is determined. If the IP address of the selected unit is not equal to the IP address of a unit included in the group of units to be managed, then step S46 is performed.

[Step S44] If the IP address of the selected unit is equal to the IP address of a unit included in the group of units to be managed, then a priority value is incremented.

[Step S45] The IP address of an application server corresponding to the unit to be managed the IP address of which is equal to that of the selected unit is registered in the priority information 700. In this case, the values of priorities set for application servers begin with one and are incremented by one.

[Step S46] Whether the IP address of the selected unit is compared with the IP addresses of all the units included in the group of units to be managed, that is to say, whether the search is complete. If the search is not complete, then the pointer is incremented, the process returns to step S42, and the IP address of the selected unit is compared with the IP address of the next unit to be managed.

By performing the above-mentioned processing procedure, priority information is set.

The cooperative application is called with application servers in descending order of priority by the process of calling the cooperative application shown in FIG. 15.

The above functions can be realized with a computer. In this case, a server program in which the contents of the functions the integrated management server should have are described is provided. By executing this program on the computer, the above functions are realized on the computer. This server program can be recorded on a server computer readable record medium. A server computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a DVD-RAM, a compact disk read only memory (CD-ROM), a compact disk recordable (CD-R)/rewritable (CD-RW), or the like. A magneto-optical recording medium can be a magneto-optical disk (MO) or the like.

To place the server program on the market, portable record media, such as DVDs or CD-ROMs, on which it is recorded are sold.

When the server computer executes this server program, it will store the server program recorded on a portable record medium on, for example, its hard disk. Then it reads the server program from its hard disk and performs processes in compliance with the server program. The server computer can also read the server program directly from a portable record medium and perform processes in compliance with the server program.

In the present invention, unit management information generated by servers on which cooperative applications are dispersedly installed is obtained, correspondence information by which cooperative applications are associated with application servers and units is generated, and an operation menu corresponding to each unit is set. As a result, a registration process for starting a cooperative application can be performed easily. Moreover, operation menus can be set automatically. Therefore, mistakes in inputting can be prevented and the registration work load can be lightened.

In addition, when a system is changed, the menus set can be updated automatically by obtaining information regarding the cooperative applications, the application servers, and the units in a new state.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A cooperative application starter program for starting cooperative applications dispersedly installed on a plurality of servers connected via a network, the program making a computer function as:
correspondence information generation means for obtaining unit management information regarding units to be managed generated by the plurality of servers on which the cooperative applications are installed and for generating correspondence information by which the cooperative applications are associated with the plurality of servers and the units to be managed on the basis of the unit management information;
menu setting means for setting operation menus for starting the cooperative applications for the units to be managed, for generating start definition information for indicating areas where objects for starting the cooperative applications associated with the units to be managed by the correspondence information are stored, and for associating the start definition information with the operation menus; and
auxiliary menu execution means for providing, at the time of any of the units to be managed being selected, an operation menu set for the unit to be managed and for starting a cooperative application by using start definition information corresponding to the operation menu selected.

2. The cooperative application starter program according to claim 1, wherein when a cooperative application or a unit to be managed is added to a server or the cooperative application installed on a server or a unit to be managed by a server is deleted, the correspondence information generation means obtains the unit management information from the server and updates the correspondence information.

3. The cooperative application starter program according to claim 1, wherein if a same unit is to be managed by a same cooperative application dispersedly installed on the plurality of servers, the correspondence information generation means sets priorities for starting for the plurality of servers.

4. The cooperative application starter program according to claim 3, wherein:
the auxiliary menu execution means starts the cooperative application installed on a server for which a highest priority is set on the basis of the priorities for starting set for the plurality of servers; and
if the cooperative application installed on the server is not started, the procedure of making a start request to a server for which a next highest priority is set on the basis of the priorities for starting set for the plurality of servers is repeated.

5. The cooperative application starter program according to claim 1, wherein the menu setting means obtains description format information for describing the start definition information set for each of the cooperative applications, inserts information regarding a server and a unit to be managed extracted from the correspondence information into the description format information, and generates the start definition information.

6. The cooperative application starter program according to claim 5, wherein the menu setting means obtains IP addresses of the server and the unit to be managed from the correspondence information, inserts the IP addresses of the server and the unit to be managed into the description format information, and generates a URL indicative of an area where an object for starting a cooperative application is stored as the start definition information.

7. The cooperative application starter program according to claim 5, wherein the menu setting means obtains the description format information from the server on which the cooperative application is installed.

8. The cooperative application starter program according to claim 1, wherein the menu setting means performs the process of generating the start definition information and associating the start definition information with the operation menus when the operation menus are set or when the operation menus selected is executed.

9. The cooperative application starter program according to claim 8, wherein:
after setting the operation menus regarding the units to be managed, the menu setting means stores in advance information regarding registered menus generated by performing the process of generating the start definition information and associating the start definition information with the operation menus in a storage means; and
when an operation menu for any of the units to be managed is selected, the auxiliary menu execution means starts the cooperative application on the basis of the start definition information retrieved from the information regarding registered menus stored in the storage means.

10. The cooperative application starter program according to claim 8, wherein:
when the menu setting means obtains a unit to be managed and an operation menu selected via the auxiliary menu execution means, the menu setting means generates the start definition information regarding the unit to be managed, associates the start definition information with the operation menu, and informs the auxiliary menu execution means of a result; and
when the menu setting means sets the start definition information, the auxiliary menu execution means starts the cooperative application on the basis of the start definition information.

11. The cooperative application starter program according to claim 1, wherein the menu setting means sets in advance menu allocation information in which the operation menus corresponding to the properties of the units to be managed are defined, and sets the operation menus on the basis of the menu allocation information according to the properties of the units to be managed.

12. A cooperative application start method for starting cooperative applications dispersedly installed on a plurality of servers connected via a network, the method comprising the steps of:
obtaining unit management information regarding units to be managed generated by the plurality of servers on which the cooperative applications are installed and making a correspondence information generation means generate correspondence information by which the cooperative applications are associated with the plurality of servers and the units to be managed on the basis of the unit management information;
making menu setting means set operation menus for starting the cooperative applications for the units to be managed, generate start definition information for indicating areas where objects for starting the cooperative applications associated with the units to be managed by the correspondence information are stored, and associate the start definition information with the operation menus; and
making auxiliary menu execution means provide, at the time of any of the units to be managed being selected, an operation menu set for the unit to be managed and start a cooperative application by using start definition information corresponding to the operation menu selected.

13. A computer-readable record medium that stores a cooperative application starter program for starting cooperative applications dispersedly installed on a plurality of servers connected via a network, the program making a computer function as:
correspondence information generation means for obtaining unit management information regarding units to be managed generated by the plurality of servers on which the cooperative applications are installed and for generating correspondence information by which the cooperative applications are associated with the plurality of servers and the units to be managed on the basis of the unit management information;
menu setting means for setting operation menus for starting the cooperative applications for the units to be managed, for generating start definition information for indicating areas where objects for starting the cooperative applications associated with the units to be managed by the correspondence information are stored, and for associating the start definition information with the operation menus; and
auxiliary menu execution means for providing, at the time of any of the units to be managed being selected, an operation menu set for the unit to be managed and for starting a cooperative application by using start definition information corresponding to the operation menu selected.
